(19) United States
(12) Patent Application Publication
(10) Pub. No.: US 2006/0222565 A1
(43) Pub. Date: Oct. 5, 2006

(54) Method for producing an arrangement comprising a plurality of layers on the base of semiconductor substrate, multi-layer arrangement, and biosensor

(76) Inventors: Prosper Hartig, Berlin (DE); Michael Portwich, Berlin (DE); Rudolf Volkmer-Engert, Berlin (DE); Joerg Rappich, Berlin (DE)

Correspondence Address: BIRCH STEWART KOLASCH & BIRCH, PO BOX 747, FALLS CHURCH, VA, 22040-0747, US

(21) Appl. No.: 11/338,686

(22) Filed: Jan. 25, 2006

Related U.S. Application Data
(63) Continuation of application No. PCT/DE04/01584, filed on Jul. 21, 2004.

(30) Foreign Application Priority Data
Jul. 25, 2003 (DE) DE 103 34 097.1
Jul. 25, 2003 (DE) DE 103 34 096.3

(51) Int. Cl. G01N 31/22

(52) U.S. Cl. 422/56

(57) ABSTRACT

A method for producing an arrangement is provided. The arrangement includes a plurality of layers, whereby an organic layer is formed on a surface of a semiconductor substrate, under the influence of irradiated light, by applying a medium containing an organic substance to the surface of the semiconductor substrate, and deposition of the organic substance. A difference in potential is created between the semiconductor substrate and the medium during the deposition of the organic substance, by applying an electrical voltage. The invention also relates to a biosensor comprising an arrangement of a plurality of layers, and to a method for measuring properties of a test constituent using the biosensor. The arrangement of a plurality of layers comprises a semiconductor substrate layer and a layer which is arranged adjacent to the semiconductor substrate layer and contains a biologically active constituent. An interaction section is formed in active communication with the layer containing the biologically active constituent, and a test substance containing a test constituent for interacting with the biologically active constituent can be introduced into said section. Furthermore, said arrangement is provided with at least one connection electrode that is electroconductively connected to the interaction section, and another connection electrode that is electroconductively connected to the semiconductor substrate layer. The at least one connection electrode and the other connection electrode form connection means for coupling to an electric circuit such that an electrical measuring quantity can be obtained between the at least one connection electrode and the other connection electrode, over the arrangement of the plurality of layers and the interaction section, said measuring quantity being able to be modified as a result of the interaction of the test constituent with the biologically active constituent.

This nonprovisional application is a continuation of PCT/DE2004/01584, which claims priority on German Patent Application Nos. DE 103 34 097.1 and DE 103 34 096.3, which were both filed in Germany on Jul. 25, 2003, and which are all herein incorporated by reference.

### BACKGROUND OF THE INVENTION

1. Field of the Invention

The present invention relates to multilayer systems based on semiconductor substrates with functionalized surfaces.

2. Description of the Background Art

The use of silicon in modern technologies is common place due to the outstanding role of silicon in the semiconductor technology and the favorable properties of this material. Various attempts were undertaken to functionalize the surface of silicon for different applications by depositing molecules and/or molecule aggregates on the surface. To functionalize the surface in this context means in particular that molecules forming the surface show properties, which let them step into provable interaction to other molecules arranged on the surface or near to the surface. To this belongs, for example, the use of a functionalized silicon surface for the investigation of biological and/or chemical activity of molecules, ions and/or elements. The proof of interactions takes place with the help of a physical transducer, for example an electrode or an optical device.

Such devices are also called biosensors.

A Biosensor is in general an arrangement, in which biologically active components, for example a protein, a DNA segment, a biomimetic or a whole cell, is coupled with or is integrated in a physical transducer.

With the help of the physical transducer a measuring signal is produced by an interaction of the biologically active element with a test component of a test substance, which can be acquired as a measured variable (measurand/quantity) metrologically. The measured variable can be of optical, electrochemical, calorimetrical, piezoelectric or magnetic nature depending on the outgoing measuring signal in well-known biosensors. Biosensors open the possibility of examining interactions between biologically active components in order to gain for example information about compounds with well-known bio activity or about the bio activity of samples with well-known or unknown chemical composition (see Keusgen: “Biosensors: new approaches in drug discovery”, Naturwissenschaften, 89 (2002) 433-444).

Beyond the use of silicon substrates with a functionalized surface as a biosensor, various applications for so arranged multilayers are possible. The functionalization of the surface of the silicon substrate in this context is variable for the change of the physical and/or biological characteristics of the coated surface. Further applications are the electronic passivation, the change of electronic characteristics, the forming of reactive surfaces and the forming of sensitive surfaces, with which apart from the use as biosensor also the binding of other molecules is possible, for example a dye. Beyond that a coated silicon substrate can be used as an intermediate layer in photovoltaics or within electronic devices, in particular in organic transistors or light emitting diodes. Within the semiconductor chip technology a biocompatibility can be achieved by the coating of the silicon surface.

The selectivity of a biosensor depends on the biologically active component or components which are contained by the particular biosensor and which interact with test components that are to be analysed. Only test components cause a measurable signal, which interact with the biologically active component enclosed in the biosensor. The predominant number of well-known biosensors is based on electrochemical transducers. Used transducers can be divided into amperometrical, potentiometrical, conductometrical and capacitive transducers. Amperometrical biosensors detect changes of a current flow through the biosensor while a constant potential is applied at the biosensor, if charge transfer takes place in the form of electrons between a biologically active component and an electrode. A typical measuring setup for an amperometrial biosensor is based for example on the immobilization of an enzyme on a surface of an electrode and on adding a solved biochemical substrate. If the enzyme interacts with the substrate a current flows, which is dependent on the concentration of the analyte. Potentiometrical biosensors detect a change of the voltage while a constant current is applied, where the current is usually zero. Compared with amperometrical biosensors here the biologically active component, for example an enzyme, can be on the surface of a pH sensitive device. With conductometrial biosensors the change of the conductivity between two electrodes is detected. Capacity measurements for the physical transformation of the measuring signal can also be used if an interaction between the test component to be examined and the biologically active component covered by the biosensor causes a change of the dielectric constant.

Electrochemical methods are well known for the deposition of molecules on silicon surfaces. A method to form a covalently bound monolayer of organic substituents on a silicon substrate is known from the document U.S. Pat. No. 6,485,986. There in an organic solution with the substituents is applied to the silicon surface. Due to the application of an electrical potential between electrodes the substituents are then deposited on the silicon surface. A further method to use an electrochemical deposition for coating a silicon surface, is well known from the document EP1271633. In this known method, a solution of diazonium compounds is put on a H-terminated silicon surface (H-hydrogen) and a cathodical potential is applied, in order to deposit diazonium ions electrochemically and to prevent the silicon from oxidation.

Further known is a method for the deposition on an H-terminated silicon surface (see Strother et al.:“Covalent attachment of oligodeoxyribonucleotides to amine-modified Si (001) surfaces”, Nucleid Acids Research, 2000 (18) 3535-3541), which uses ultraviolet light to trigger the reaction of the deposition of molecules on a silicon surface. Silicon radicals on the silicon surface are formed in the context of the photoreaction.

### SUMMARY OF THE INVENTION

It is therefore an object of the present invention to provide an improved method for the preparation of an arrangement of several layers/comprising a plurality of layers (multilayer), whereby a semiconductor surface is coated with an organic substance for a functionalization, e.g. by an organic substance having/providing/exhibiting a functional group for coupling species, as well as to provide a multilayer system/multilayer, in particular a multilayer wherein at least parts of the interface organic layer/semiconductor substrate are free of silicon oxide, with a coated semiconductor surface which can be implemented with the help of simple means and produced economically.

A further object of the present invention is to provide an improved biosensor based on the multilayer system as well as an improved method for measuring with the help of the biosensor characteristics of a test component/test constituent, which interacts with one or more biologically active components/constituents of the biosensor, making it possible to determine information about the characteristics of the test component of a test substance, executable with the help of simple instrumentation.

In one embodiment of the present invention an organic layer on a surface of a semiconductor substrate is formed during the preparation of a multilayer system (arrangement of several layers) under influence of irradiated light, in particular ultraviolet light, e.g. with a wavelength of 100 nm-500 nm, by applying or superimposing an organic substance containing medium to the surface of the semiconductor substrate and by depositing the organic substance. During the deposition of the organic substance a difference of potential, preferably in the range of 0-10 V or 0-1 V, in particular 1-2 V, compared to a reference such as a electrode, e.g. a Ag/AgCl electrode, between the semiconductor substrate and the medium is set/produced due to the application of an electrical voltage, in particular by connecting the semiconductor substrate and/or the medium with a source of voltage and/or current, e.g. a potentiostat or a battery, by the use of electrically coductive means (e.g. electrodes, wires, conductive paste or adhesive, or similar means) such as by the means and procedures being described for the biosensor, below. Also, all other materials, substances and procedures being described therein are, inter alia, applicable to perform the inventive method.

A substantial advantage of the present invention is the adjustability of the manufacturing process to most different requirements, as the deposition of the organic substance takes place under conditions where a combination of irradiated light and an electrical voltage is used.

The medium including the organic substance can be illuminated with light before and/or after it is superimposed, in order to form/release photo radicals, whereby the wavelength of the light is selected as a function of the photo reactive substance and whereby the organic substance and/or the semiconductor substrate can be photo reactive. Light irradiation can be intended also during the superimposing of the medium. At the formation of photo radicals in the medium, the developing photo radicals are deposited on the terminated surface of the semiconductor substrate, whereby the photo radicals form covalent bonds with elements of the semiconductor substrate within the range of the surface, so that on the terminated surface of the semiconductor substrate an organic layer is formed.

The term photo radicals as used here refers to photochemically (i.e. by photolysis) produced/formed/released reactive compounds and/or molecule moieties, atoms or ions, in particular radicals and/or electron deficiency compounds, e.g. a nitrene.

The medium can be formed by the organic substance itself or by a solution of the organic substance. In a further embodiment of the present invention working without inert gas atmosphere is facilitated by the fact that for a solution, an aqueous electrolyte is used.

In contrast to the conventional art, the present invention provides for the possibility of purposefully controlling the chemical, physical and/or biological characteristics of the semiconductor substrate by an electrical voltage. It is possible through this, for example, to obstruct the oxidation of the semiconductor substrate. The oxidation of a silicon substrate has for example the unfavourable effect that the electrical permeability of the material is at least reduced. A complete oxidation limits the use of such a substrate for electrochemical measurements. The use of the electrical voltage, in particular a non anodic electrochemical potential, e.g. by a current with fixed current flow direction or a charge with fixed sign (e.g. a + or − prefix), during the deposition of the organic substance, preferably before and during the deposition of the organic substance, prevents the formation of oxide within the range of the surface of the semiconductor substrate. Due to the prevention of the oxide formation, a disturbing influence of the oxide, in particular regarding to a reduced conductivity, is prevented across the formed multilayer system. Compared with well known procedures, where the oxide formation, in particular the silicon oxide formation, is prevented for example with the help of the execution of the deposition procedure under an inert gas atmosphere (see Strother et al:“Covalent attachment of oligodeoxyribonucleotides to amine modified Si (001) surfaces”, Nucleid Acids Research, 2000 (18) 3535-3541), is the use of the electrical voltage of the present invention economically and easy to perform with the help of simple means. Thus, for example, no vacuum equipment is needed.

Furthermore the preferential use of the non anodic potential, e.g. a cathodic potential, has the advantage that the potential can support an oriented binding of the organic substance with dipole moment to the semiconductor atoms of the substrate.

The use of semiconductors (for example silicon), in particular single crystal silicon, as a basis substrate is substantially more economical compared with other conductive substrates, for example single crystal gold. The surface of silicon is self passivating in contrast to gold. Scratches on the silicon surface or surface defects do not induce a short circuit of current across the solution. The silicon surface is passivated immediately within the range of the defects by oxidation with a conductivity going against zero, so that the current, i.e. preferably in the range of 0-1 A, 0-100 mA, 0-100 μA or 0-100 nA, is flowing further with priority via (over/across) the organic layer and/or the potential drop remains over the organic layer. Furthermore the surface of the silicon substrate is structurable as far down as to the range of atomic layers. The terminated surface can be formed atomically flat/smooth, which facilitates a defined, and with respect to the surface geometry of the silicon substrate, surface orientated binding of the photo radicals.

Often it is desired to control in means of time the reaction between semiconductor substrate and organic substance in order to optimize the deposition. In this case substances are advantageous, which react only to a purposeful application of light. In one embodiment of the present invention the semiconductor substrate and/or the organic substance can be photo reactive/photo labile. For example in this way it can be prevented before the deposition process starts that the substrate and/or the organic substance already react independently.

In a further embodiment of the present invention it can be intended that the electrical voltage, in particular the non anodic potential, is adjusted/set for the directed/purposeful orientation/adjustment, compared to the spatial orientation of the surface or surface layer, of the photo radicals in the organic layer. Through this, the possibility is created of purposefully affecting the binding of the photo radicals to the semiconductor substrate surface, for example as a function of the used photo reactive substance and/or to avoid undesirable secondary reactions.

The formation of covalent bonds of the organic substance with the semiconductor layer in one embodiment of the present invention can support the conduction of current through/via the multilayer system with organic layer and semiconductor substrate layer as well as layer stability, in particular regarding oxidation of the surfaces. Furthermore, no recombination active defects thereby arise. Moreover a high adhesiveness and stability of the multilayers are supported.

An especially simple creation of the multilayer is reached by applying the medium as a solution of the organic substance. Through this the application of an electrical voltage is promoted. Further solutions are usually optically permeable (transparent) and make possible the simultaneous application of light to the substrate and the organic substance in the solution. The solution can either contain the organic substance or is the latter or form a combination of both.

In a further embodiment of the present invention, the formation of covalent bonds includes the formation of HL-N-bonds (HL—semiconductor substrate, N—nitrogen) between the organic substance and the semiconductor substrate, which results in a further improvement of the conductivity through the multilayer system. A possibility to check the layer deposition on the semiconductor substrate, executable with the help of simple instrumentation, is, in an embodiment of the present invention, given by measuring at the semiconductor substrate a photo voltage and/or an electrical conductivity and/or a photoluminescence of the surface.

A coupling of different species to the multilayer, which includes the semiconductor substrate and the deposited organic layer thereon, is reached in an embodiment of the present invention by forming the organic layer as a linking layer/bonding layer for coupling species, such as molecules, ions and/or elements as well as components, which are made up of these.

In this case the species can be obtained/achieved/derived from a conventional cross linker and/or so called photo linker being used as the organic substance for the deposition.

In order to configure the formed multi layer system for applications to immobilize molecules, ions and/or elements with biologically active characteristics, in a further embodiment of the present invention, molecules are used as organic substance for forming the linking layer, which exhibit at least one coupling group for biologically active components. Through this, the surface of the semiconductor substrate achieves certain suitability, such that biologically active components can be bound.

Preferentially, in an embodiment of the present invention, the biologically active component can be coupled to at least one coupling group with the help of a chemical reaction and/or non covalent interactions. Through this it is possible to functionalize the surface of the semiconductor substrate for the purpose of investigating the biologically active components. By this, the biologically active components are coupled to the semiconductor substrate by the linking layer.

Appropriately, in an embodiment of the present invention, an organic substance, in particular a photo reactive substance can be an aryl azide compound, a benzophenone derivative and/or a diazirine derivative. Particularly preferred as organic substance are halogen aryl azide compounds, for example fluorine aryl azide derivatives. This class of compounds can be provided with different forms of coupling groups, which are stable during the photo induced deposition processes on the one hand, i.e. intra molecular reactions also arise in a decreased form, and on the other hand they exhibit the ability, dependent on the coupling group, to bind various molecules, ions and/or elements.

In a preferred embodiment of the present invention a silicon substrate is used as the semiconductor substrate. As substrate a silicon single crystal, polycrystalline silicon, porous silicon or amorphous silicon is used, preferentially with 1-1-1, 1-1-0 or 1-0-0 surface orientation and/or main orientation, from 0,01-1000 OHMcm, preferably 0,1-100 OHMcm, in particular 0,5-100 OHMcm, especially 1-10 OHMcm, thus the deposition of close, compact organic layers is supported. The term silicon substrate includes silicon compounds, silicon alloys and silicon with implemented foreign atom/ions (doping).

In a preferred embodiment of the present invention the semiconductor substrate is used with an atomically flat surface in order to achieve on the surface of the semiconductor substrate in respect to it oriented molecules and a high density of components.

Advantageously in an embodiment of the present invention the organic layer is formed as a close/densly/tightly packed layer. Through this an area as large as possible of the terminated surface of the semiconductor substrate is passivated, and also the functionalized surface is as large as possible.

In order to prepare the multilayer for different applications, in an embodiment of the present invention the organic layer or layers are structured lithographically. Possible applications arising from this are for example given in the overview article of Stewart et al.: “Chemical and Biological Applications of Porous Silicone Technology”, Adv. Mater., 12 (2000) 859-869, which is incorporated by reference herein.

A molecular structuring of the surface of the produced multilayer, which is important, for example, for the use of the produced multilayer as sensor for glucose or suchlike, is done in an advantageous embodiment of the present invention by processing the organic layer with the help of an Imprinting procedure.

In a further advantageous embodiment of the present invention quantum dots are formed in the organic layer. Thus the organic layer can be provided with predetermined optical properties, for example, for the use of the multi layer in the laser technology or in a quantum computer.

In a favourable embodiment of the present invention the semiconductor substrate has a 1-1-1 surface orientation, whereby, within the range of the terminated surface, bonds of the semiconductor substrate are made available standing basically perpendicular bonds to the surface.

The terminated surface of the semiconductor substrate is favoured to be H-terminated (H—hydrogen), whereby a technology already tested is usable for the termination of the surface.

Another aspect of the present invention concerns a biosensor for the detection of a biological object based on a semiconductor substrate layer and an organic linking layer, the latter being formed by depositing an organic substance, in particular photo radicals, on a terminated surface of the semiconductor substrate layer, whereat the organic linking layer is bound to the semiconductor substrate layer by covalent bonds, the organic linking layer bound to the semiconductor substrate layer includes at least one coupling group for biologically active components and one or more biologically active components are coupled to each of the at least one coupling group. Such a biosensor shows the advantages arising from this due to its constructional design independently of the production method. The biosensor can be produced not only with the help of the method and means, and the features resulting thereof, described above, but also using other production processes. These properties of the biosensor exhibit the advantages specified in the referring methodical claims.

Measuring equipment, e.g. a measuring device for measuring a current, a voltage (e.g. by a cyclic voltammogram), a charge and/or a charge flow preferably amperometrically, voltametrically or coulombmetrically such as a potentiostat may be, for measuring an electrical quantity (measured variable) to be measured via/across the multilayer, in particular the electrical conductivity can be provided at the biosensor.

It can be intended to adjust the biosensor with the arrangement of several layers for certain measuring requirements, in particular an electrical conductivity measurement.

For this purpose the biosensor has an interaction section intercommunicating to the biologically active component, in which a test substance including a biological test component can be brought in for interacting with the biologically active component, and it has a connecting electrode, which is connectable in an electrically conductive way to the test substance in the interaction section, and at least one further connecting electrode, which is connected/in physical connection to the semiconductor substrate layer electrically conducting, i.e. to act as a conductor, whereby with the help of at least one connecting electrode and the further connecting electrode junction (connections) are formed for coupling to an electrical circuit, so that between at least one connecting electrode and the further connecting electrode across the system including the semiconductor substrate layer as well as the organic linking layer and the interaction section an electrical quantity can be tapped, for example an electrical conductivity, which changes as the case may be due to the interaction of the biologically active component and the test component of the test substance in the interaction section.

The biosensor is very simple designed and exhibits a large sensitivity, because of the possibility to measure electrical quantities directly across the layers. A preferred electrical quantity can be the electrical conductivity, but it is also possible to use the capacity, the dielectricity, the voltage and/or the electric current as quantity.

The semiconductor substrate layer is here in particular in the range of the deposited organic layer and/or in the range, within which the conductivity is measured, formed largely free of oxide, if appropriately provided with a non closed/complete oxide coating, which can be a non closed/complete silicon oxide layer in the case of the use of a silicon substrate layer. As substrate a silicon single crystal, polycrystalline silicon, porous silicon or amorphous silicon is used, preferentially with a 1-1-1 surface orientation and/or main orientation, which makes the deposition of closed, compact organic layers possible. The term silicon substrate includes also silicon compounds, silicon alloys and silicon with stored foreign atoms/ions (doping). This applies to other semiconductor substrates accordingly. Test components are in particular molecules, ions and/or elements as well as composed components formed there of.

The advantage of the use of the system based on the semiconductor substrate layer, in particular a silicon substrate layer, is that semiconductors, in particular silicon, are not toxic, and compared with metals, as used in current technologies, for example gold, it is economically available and easily structured by standard technology. The surface of silicon in contrast to gold is self passivating. Scratches on the silicon and/or surface defects, e.g. in the organic layer and/or silicon, do not lead to a short circuit in terms of electrical current across the solution. Within the range of the defects the silicon surface is passivated immediately by oxidation with a conductivity going towards a value of zero, so that the current further flows across the organic layer with priority and/or the decrease of potential across the organic layer remains. From semiconductor technologies suitable technologies are well known for the supply of a desired surface of the silicon substrate. For example it is favourable to use an H-terminated surface.

There is further the advantage of the electrical measurement, for example compared to optical measurements, that it is executable with the help of simple instrumentation means and exhibits a large sensitivity.

In an appropriate further embodiment the interaction section is formed as an area with a supply opening and a discharge opening, where the test substance is able to pass/stream/flow through, and where the test substance is able to flow through in liquid or gaseous form. By this a continuing exchange of the test substance is made possible with use of the biosensor for measuring.

Preferably the organic linking layer with the linking molecules, in particular comprising one or more coupling (e.g. chemically reactive) groups, for example charged (e.g. acidic or basic) groups, a maleimide or a succinimidyl ester, for coupling species (e.g. by a chemical reaction), is produced by a light induced photo reaction, where in particular the linking molecules and/or the semiconductor substrate are photo reactive and form photo radicals. The term of photo radicals refers, as described above, to photochemical produced/formed reactive compounds and/or molecule moieties, atoms or ions, in particular radicals or electron deficiency compounds. In contrast to known methods, where the processes have to be done in an inert gas atmosphere, the use of a non anodic, electrochemical potential and of photo radicals as linking molecules makes it possible to produce the linking layer in a simplified manner.

In an preferred embodiment an optimized conductivity is reached by the fact that the chemical bonds in between the organic linking layer and the semiconductor substrate layer include HL-N-bonds (HL semiconductor substrate), in particular Si—N-bonds.

Appropriately in an embodiment of the present invention the organic substance is formed on the basis of an aryl azide compound, a benzophenone derivative and/or a diazirine derivative. Particularly preferred as linking substance are halogen aryl azide compounds, for example fluorine aryl azide derivatives. This class of compounds can be provided with different forms of coupling groups, which are stable during the photo induced deposition processes on the one hand, i.e. intra molecular reactions also arise in a decreased form, and on the other hand they exhibit the ability, dependent on the coupling group, to bind various molecules, ions and/or elements.

The conductivity measurement can be done appropriately with the help of a current measurement or a potential measurement. Thereby it is favourable to keep one of the two quantities constant. The current measurement with constant electrochemical potential is favourable, since it is more sensitive compared to potential measurements.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a device for the deposition on a silicon substrate surface;

FIG. 2 shows a diagram of the change of photo voltage during etching a silicon oxide layer on the silicon substrate with constant non anodic potential;

FIG. 3 shows a diagram of the change of photo voltage during the deposition on the silicon substrate with constant non anodic potential;

FIG. 4 shows a diagram of the change of a photo voltage during the deposition of peptide molecules on the coated silicon substrate with constant non anodic potential;

FIG. 5 shows the structure of TFPAM-6;

FIG. 6 shows a schematic representation of a multi multilayer system;

FIG. 7 shows a schematic representation of an instrumentation including a biosensor;

FIG. 8 shows a schematic representation of a multi layer system;

FIG. 9 shows a diagram of a current time curve in a buffer solution with constant voltage;

FIG. 10 shows a diagram of a current time curve in a buffered solution including biotinylated peptide and streptavidin at constant voltage;

FIG. 11 shows a diagram of a current time curve in a buffer solution from biotinylated peptide and streptavidin with constant voltage; and

FIG. 12 shows a schematic representation of a biosensor with connecting electrodes.

### DETAILED DESCRIPTION

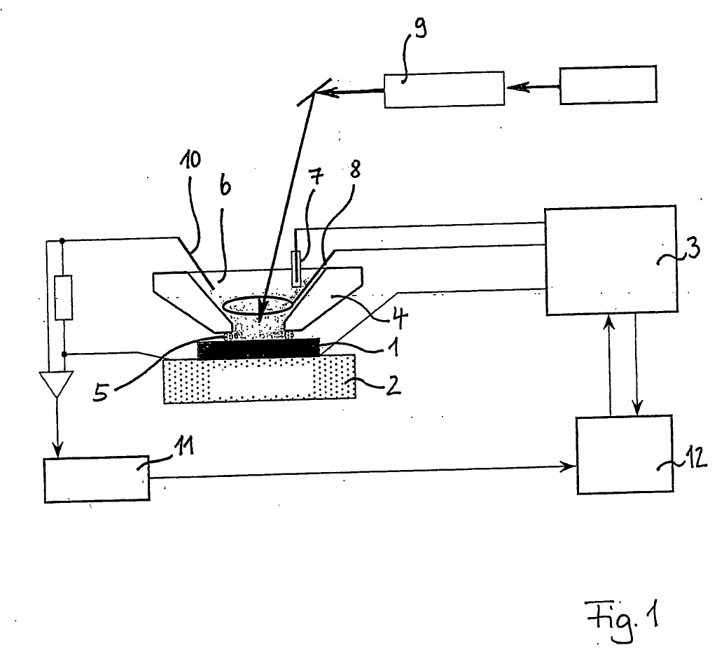

With reference to FIG. 1 to 4 in the following an embodiment for the preparation of a multi layer system is described, whereby a base layer is formed by a silicon substrate. FIG. 1 shows a schematic representation of a system for the deposition on a silicon substrate surface.

The basis material is a p and/or n doped Si (111, 110 or 100) single crystal wafer 1, 0,01-1000 OHMcm, e.g. a p-Si (111) having 0.5-1.5 OHMcm, covered with a natural oxide. The wafer 1 is cleaned according to standard methods Kern 1 & 2 (RCA 1 & 2, which are proposed by W. Kern in RCA Review, vol. 31, page 187, 1970), such as being described in the methods of EP1271633, which is incorporated herein by reference. On the back side of the wafer 1 the oxide is completely removed by a HF solution, e.g. an aqueous 5% HF solution, and a contact, e.g. an indium gallium paste, is put on the back side (back side contact). The wafer 1 is put on a metal plate 2, which is electrically connected to a potentiostat 3. A teflon container 4, open at its bottom and its top, is pressed downward on the front of the wafer 1 by screws present in the metal plate 2, whereby a Viton compound sealing ring 5 is present between wafer 1 and teflon container 4. By this a downward closed container 6 is formed, where a solution can be filled in, with the silicon surface as bottom plate. Two gold wires 7, 8 run down into the solution from the edge of the upper opening of the container 6 and are electrically connected to the potentiostat 3, whereby one of the gold wires 7 serves as reference electrode and the other one of the two gold wires 8 serves as counter electrode. The wafer 1 represents the working electrode (three electrode setup), and the potential of the silicon surface can be adjusted at the potentiostat to be a non anodic potential if the solution is conducting.

At the potentiostat 3 an electrochemical potential of −1 V is preset and it is switched from equilibrium rest potential (“silent potential”) to “potentiostatic”. A change of the photoelectric voltage is measured over a third electrode 10 (gold lead), which is in contact with the solution, meanwhile illuminating the silicon surface of the wafer 1 with the help of a pulsed laser 9 (362 mm). The photoelectric voltage is a measure for the band bending of the silicon surface, which is dependent on charges at the boundary of the surface silicon/solution. An oscillograph 11 indicates the change in the photoelectric voltage between the gold electrode 8 and the silicon wafer 1, measured at a light pulse, and the maximum of the change can be read out by means of a computer 12.

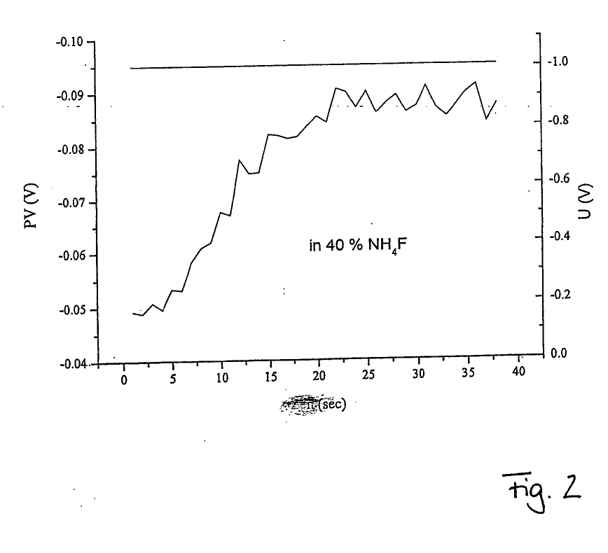

The container 6 is filled with 40% NH4F (ammonium fluoride). The ammonium fluoride corrodes the silicon oxide on the wafer 1 and leads to an atomically flat, teraced, hydrogen terminated (H-terminated) silicon surface having a 1-1-1-surface orientation. FIG. 2 shows a measurement of the maximum change of the photoelectric voltage as a function of time since the beginning of the (chemical) etching/corrosion. With a potential, constantly applied, of −1 V (see upper curve in FIG. 2) the maximum change of photoelectric voltage of approximately −50 mVs increases up to approximately −100 mVs in the process of removing the oxide and remains almost constant when corroding the H-terminated surface. After a few minutes the ammonium fluoride is completely evacuated. The electrochemical potential of −1 V being applied prevents the formation of silicon oxide at the silicon surface in contact with the solution during the deposition and thereby makes possible the deposition on an oxide-free silicon surface, also without inert gas atmosphere, even in aqueous electrolytes.

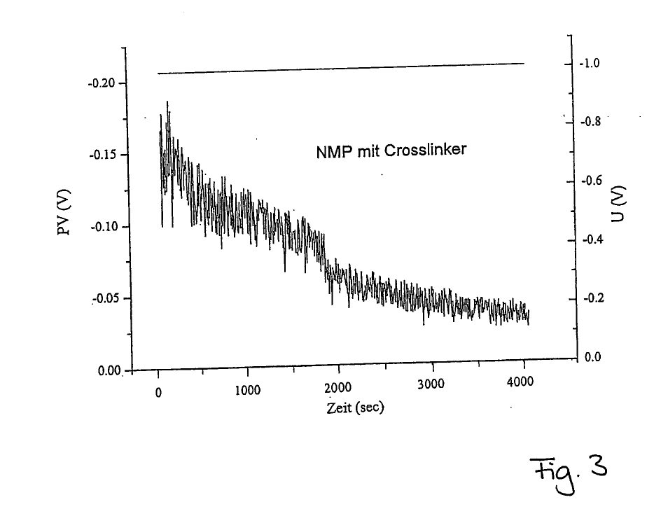

A solution of molecules of a photo-reactive (photo labile) substance in NMP (n-Methylpyrrolidon) is filled into the container 6. Lighting with the help of ultraviolet light (362 nm) of the laser light leads over a radical reaction to the interchange of molecules of the photo-reactive substance with hydrogen atoms on the silicon surface, so that on the silicon surface a layer for binding is formed. FIG. 3 shows a measurement of the maximum change of the photoelectric voltage at a constant anodic potential (see upper curve in FIG. 3) during the deposition of molecules of the photo-reactive substance on the silicon surface as a function of time. The maximum change of the photoelectric voltage decreases from approximately −150 mVs up to approximately −30 mVs in less than one hour. After somewhat more than one hour (75 minutes) the solution of the molecules of the photo-reactive substance in NMP is completely evacuated. Remains of unbound molecules in the container 6 are removed by repeated rinsing of the container 6 with NMP and ethanol (filling and evacuating). After this processing step the silicon surface is coated. In the case of the use of a photo-reactive substance suitable for a respective application the silicon surface is then user-specifically functionalized. The use of the non-anodic potential for the prevention of an oxidation of the silicon surface is no longer necessary in the following steps. It can be worked with any solutions, for example with basic-physiological buffers.

A multilayer, which exhibits a silicon substrate having a functionalized surface, which is coated by using a suitable photo-reactive substance by means of the described procedure, can be used in various applications.

The inventive functionalization of the surface of the silicon substrate, in general, serves for changing the physical, biological and/or chemical characteristics of the coated surface. Applications comprise, in particular, electronic passivation, the change of electronic characteristics, the formation of reactive surfaces and the formation of sensitive surfaces, with which, apart from the use as a biosensor, can also be used in the binding/coupling of other molecules to the surface is possible, for example of a coloring material or dye.

Beyond that, a coated silicon substrate surface can be used as an intermediate layer in the photovoltaic or in the diode technology. In connection with the semiconductor chip technology, the integration of the multilayer being formed by means of the described procedure into (technical) components can provide a biocompatibility of the coated silicon surface as well as the advantages of the today's silicon technology (lithography, integrated circuit technology, etc.).

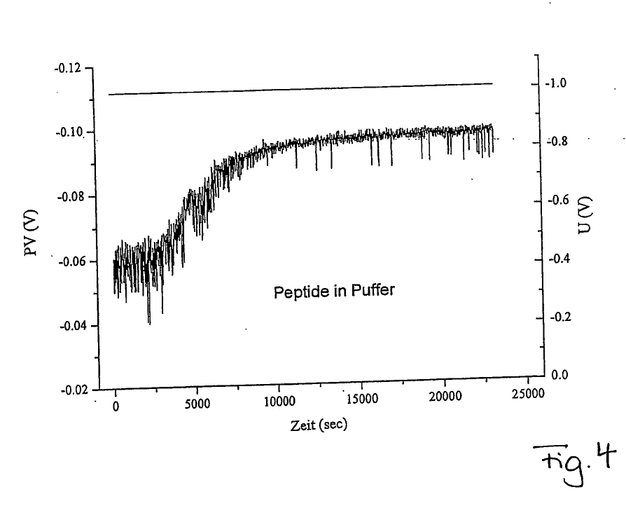

Subsequently, sodium phosphate buffer pH 7.4 with solved peptide molecules is filled into the container 6. The peptide molecules chemically react with the organic molecules deposited from the photo radicals, which are bound to the silicon surface, so that on the silicon surface, mediated by the photo radicals bound to the silicon surface, a biologically active layer comprising peptide molecules is formed. FIG. 4 shows a measurement, being dependent on the time after filling in the peptide buffer solution, of the maximum change of the photoelectric voltage at a constant electrochemical potential (see upper curve in FIG. 4) during the deposition (binding) of the peptide molecules on the silicon surface being covered with molecules of the organic substance. The maximum change of the photoelectric voltage increases from approximately −60 mVs to approximately −100 mVs in less than 3 hours and then hardly changes. Afterwards, the solution is completely evacuated and the peptide molecules, being not bound, are removed from the container 6 by repeated rinsing with sodium phosphate buffer pH 7.4.

The use of a pulsed laser light is not necessarily essential for the production of the photo radicals, but is for the measurement of the photoelectric voltage. Sufficient for the production of the photo radicals is irradiation with a more economical source of light, for example a lamp, which radiates light with the necessary wavelength. The results being represented in FIG. 3 and 4 reflect the change of the band bending in the silicon surface meanwhile the deposition processes. The results are similar to the reaction curves meanwhile the formation of chemical interconnections. A (well-) known dependency between such changes and the occurring chemical reactions, in this way, allows direct conclusions on the chemical reaction taking place at the same time. The advantage of using the pulsed laser light is the possibility of measuring the photoelectric voltage and thus, with a well known correlation between band bending at the silicon surface and the just occurring chemical reaction also slow chemical reactions can be observed in real time by measurement of the photoelectric voltage.

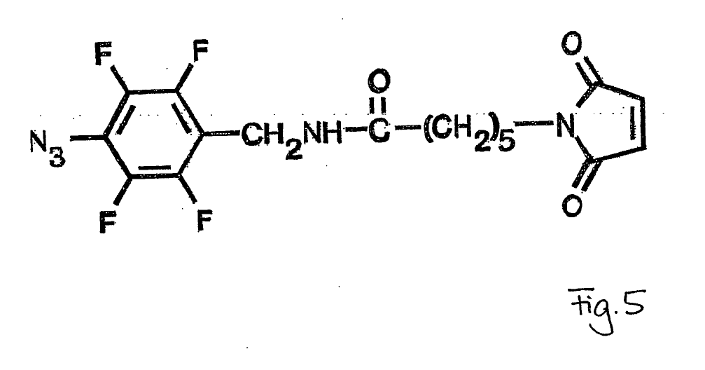

FIG. 5 shows the structural formula of N-(4-azido-2,3,5,6-tetrafluorobenzyl)-6-maleimidyl-hexanamid (TFPAM-6). It is a molecule usable as a photo-linker providing a coupling-group for bonding molecules, for example biologically active molecules. During the radical formation due to the light irradiation N2 is separated from the azido group (by expulsion), so that the evolved/produced radical can undergo a covalent bonding, over the remaining nitrene (i.e. a biradical), with the silicon. Suitable organic substances are, for example, aryl azide compounds, a benzophenone derivative and/or a diazirine derivative. Also several of these kinds of compounds/derivatives can be comprised. Particularly, halogen aryl azide compounds are preferably used. In general, all photo-labile ring structures, in particular all different photo labile heterocyclic structures, e.g. NMP, are suitable for the inventive method, thus dependent on the light and time necessary for the photo-radical production. Such compounds can be manufactured in different forms having different groups for coupling.

The different groups for coupling make possible selective reactions with only selected biologically active components. The biologically active components can be, for example, peptides, proteins, carbon hydrates, lipids, biomimetics, organelles, whole cells, tissue, nucleic acids, drugs or similar components. Also, it is possible to bond a lipid layer into which, in a following step, a trans-membrane protein, for example rhodopsin, is incorporated. Here, the deposition of the biologically active components can also take place in basic solutions, substantially supporting the stability of many biologically reactive molecules. Meanwhile depositing the biologically active molecules the deposited linking layer of the photo radicals protects the surface of the silicon substrate from corroding reactions in basic electrolytes at the silicon substrate and, as a result, from roughening of the surface of the silicon substrate, thus also protecting from a separating/dissolution of the organic layer by underetching/undercut. The photo radicals of the photo-reactive substance produced by means of the photochemical reaction are bound covalently as molecules and provide a high adhesive strength and a chemical stability of the linking layer on the silicon substrate.

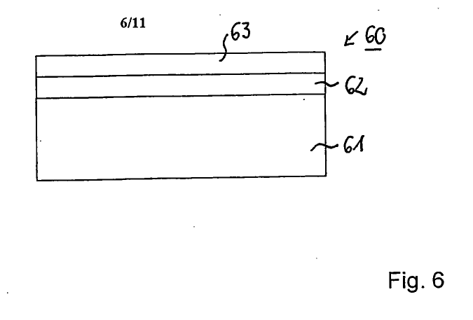

FIG. 6 shows a schematic representation of a multi-layer 60 comprising a silicon substrate layer 61, an organic layer 62 being arranged on that, which is derived from the photo radicals bonded to silicon atoms of the silicon substrate layer 61, as well as a layer 63 of biologically active molecules (e.g. comprising nucleotide or amino acid residues), supported on the organic layer 62. The layer 63 can be bound covalently, by a salt bridge, by an electrostatic interaction, by a hydrophobic interaction, Van der Waals interaction, by their combination or in a similar way.

The multilayer 60 can be used, for example, as a biosensor for the investigation of chemical, physical and/or biological characteristics of the biologically active molecules.

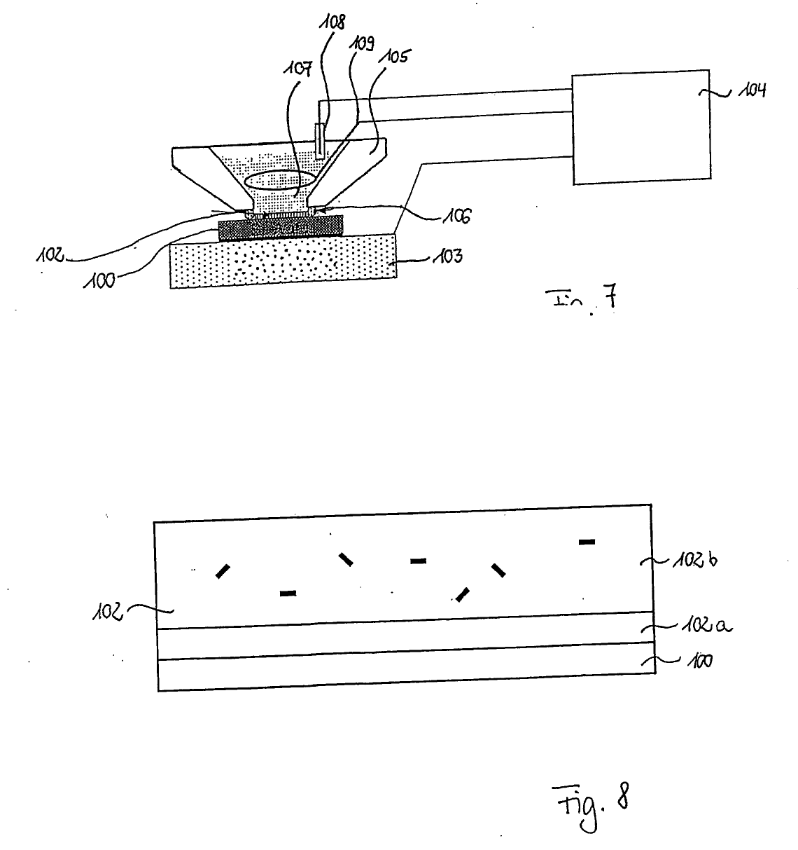

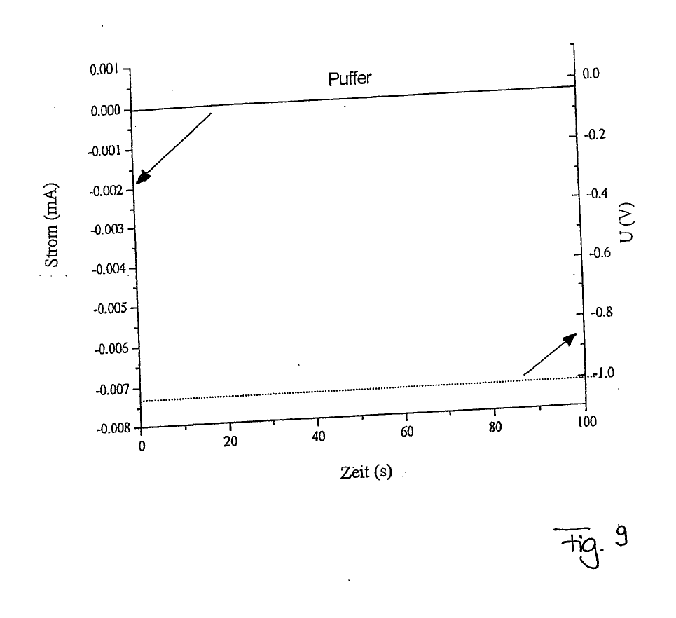

FIG. 7 shows a schematic representation of a measuring device for performing a measurement of electrical conductivity at the biosensor. The used biosensor comprises, in the execution example according to FIG. 8, a multilayer with a single-crystal silicon wafer 100 having an atomically flat surface and a 1-1- 1-surface orientation, being covered by an organic layer system 102, which comprises a layer 102a of linker molecules (cross-linker) being directly deposited on the wafer 100, a layer 102b of biologically active components, for example peptides (a non homooligomerizing leucine zipper), whereby the biologically active components are coupled to the wafer 100 with the help of the linker molecules by means of covalent chemical bonding.

According to FIG. 7 an Indium gallium paste is brought up on the back of the silicon wafer 100, over which exists a good electrical contact to an underlying metal plate 103. The metal plate 103 is connected with a potentiostat 104, which preferably comprises a computer in the form of a usual personal computer or is connected with the same. On the front of the silicon wafer 100, which is coated with organic substances, a teflon container 105, being open upward and downward is arranged. A Viton-sealing ring 106 between the teflon container 105 and the silicon wafer 100 ensures, that no solution runs out, if the container 105 is filled with a solution, which is, in the case of the execution of a measurement, a biological test substance. Thus, the coated silicon wafer 100 represents the soil of the container 105. The teflon container 105 is fixed over screws being connected with the metal plate 103. In the container 105 an interaction section 107 is formed above the organic layer system 102, in which the biological test substance is brought in for measuring purposes, so that molecules in the test substance can interact with the biologically active components in the layer system 102.

Two gold leads 108, 109 run into the container 105 from above into the interaction section 107, being formed as connection electrodes, which are electrically connected with the potentiostat 104. In this connection a gold wire 108 serves as a reference electrode serves, a gold lead 109 serves as a counter electrode, and the coated silicon wafer 100 represents a working electrode (three electrode setup). With a conductive solution (biological test substance) in the container 105 a constant potential of approximately −1 V at the Potentiostat 104 is applied.

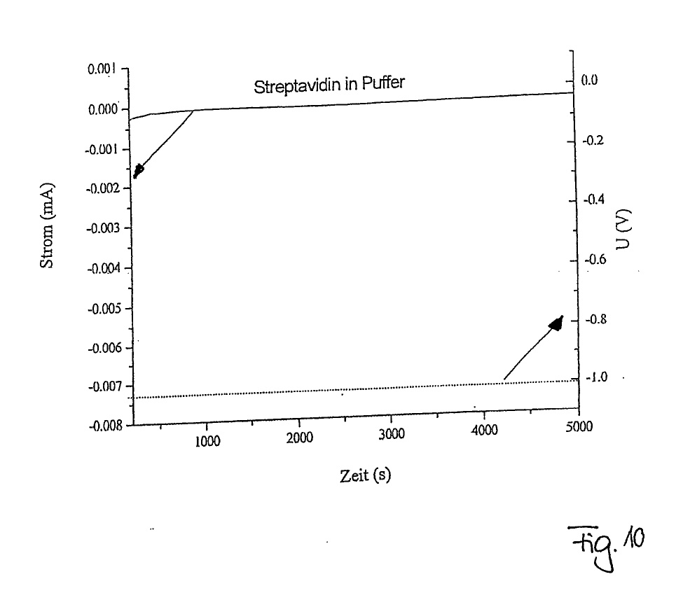

FIG. 9 shows a measurement of the current being dependent on the conductivity as a function of time after applying the buffer solution to the interaction section. At a constantly applied potential of −1 V the current is constant and smaller than 1 μA.

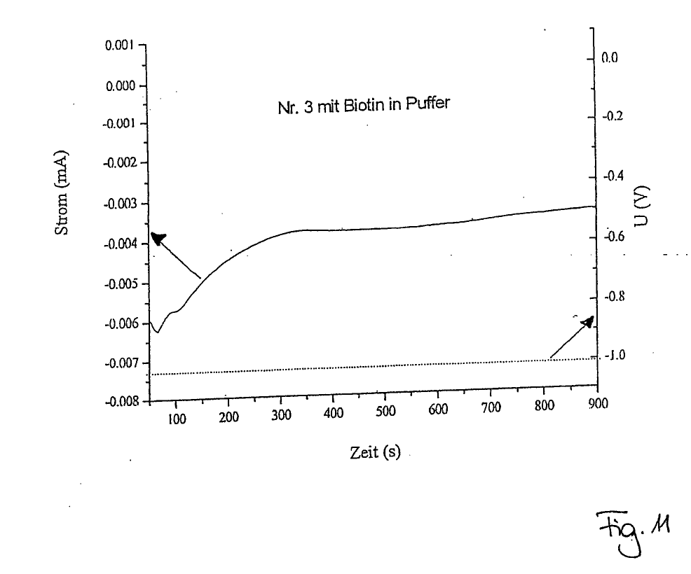

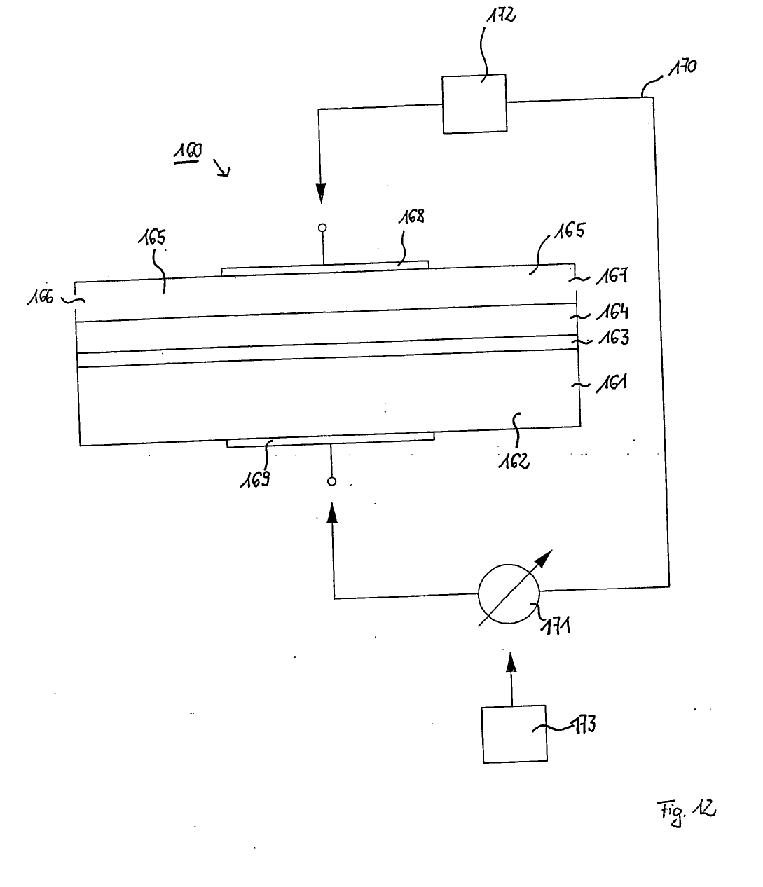

After adding Streptavidin to the buffer solution (see FIG. 10) the current drops again within a short time to a value smaller than 1 μA. Streptavidin does not bind to the peptide, with which the silicon wafer 100 is coated (negative control). After repeatedly rinsing the container 105 (filling in solution and evacuating completely) by the use of buffer solution a solution with biotinylated peptide No. 3 and Streptavidin in buffer is filled in the container and leads to a strong rise of the current to a value of >3 μA (see FIG. 11). The biotinylated peptide No. 3, which is able to bind Streptavidin over its biotin label, binds to the peptide with which the silicon wafer 100 is coated. The biosensor indicates this interaction time-dependently in real time as a change in conductivity in the form of a substantially larger current flow.

FIG. 12 shows a schematic representation of a biosensor 160 with a multi-multilayer 162, comprising a silicon substrate layer 161, and on that a deposited layer 163 of linker molecules, which are bonded covalently to chemical connections over with the silicon of the silicon substrate layer 161, and a further layer 164 with biologically active components, located on the layer 163. Above the further layer 164 a interaction section 165 is formed, in which a test substance with a test component, for example being a solution or suspension, can be brought in, so that the test component can get into interaction with the biologically active component of the further layer 164. The interaction section 165 provides two openings 166, 167, so that the interaction section 165 can be flowed through by the test substance. A connection electrode 168 is attached to the interaction section 164.

A further connection electrode 169 is in electrical contact with the silicon substrate layer 161 and is, for example, attached with the help of an electrically leading paste without silicon oxide or is realized by means of vaporizing gold on surface being free of silicon oxide. With the help of the connection electrode 168 and the further connection electrode 169, which are appropriately made of a suitable metal, for example gold, connection means are formed for connecting the biosensor 160 to an electrical current circuit 170, which on the other hand provides the measuring device 171 according to FIG. 12, which optionally comprises an indicator device and an electrical source of potential 172. The comprised indicator device can be, for example, an optical display, which makes possible the registration of a certain electrical conductivity and/or a certain change in conductivity by a change in colour, which can correspond respectively to a certain interaction between the test component in the test substance and the biologically active component in the further layer 164. With the help of the electrical circuit measuring signals can be measured between the connection electrode 168 and the further connection electrode 169 for determining the electrical conductivity and its change over the multilayer 162 and the interaction section 165. Alternatively, the registered measured values can be recorded in an electronic, magnetic or optical memory device 173 being integrated into the measuring instrument or being implemented separately, in a suitable form, so that the measured values are provisional for a later read out and evaluation using a suitable device, for example a computer.

The registered measured values supply information about an existing or non existing (negative control) interaction in the interaction section 165 between the test component of the test substance and the biologically active component in the further layer 164. The electric circuit 170 can be adapted individually by the person skilled in the art to different measuring techniques for the respective application, in particular with regard to the necessary electrical potential and the necessary measuring instruments. The biosensor 160 and the electric circuit 170, also including the electronic memory 173, can be integrated, for example in the form of a single chip, in particular as a bio sensory measuring system for mobile applications.

The bonding between the immobilized biologically active component and the dissolved test component, being observable in FIG. 10, is caused by various interactions in the solution. On the one hand changes in conformation of the immobilized component take place under the formation of a helical secondary structure and an association, by means of hydrophobic interactions and by electrostatic interactions (salt bridges), occurs with the peptide No. 3 being dissolved in the buffer. These interactions are dependent on several factors, for example on the solvent, the ion strength, the pH value and the temperature. Further, peptide No. 3, which on its part also undergoes changes in its conformation, is labelled with a low-molecular molecule, biotin, via which it is in reciprocal interaction, in the form of binding, with the protein streptavidin being in the solution.

With the help of the described biosensor it is possible to detect all conceivable biological and biochemical interactions, at which it comes to a change in conductivity in consequence of the interactions between the immobilized biologically active component and the test component in the solution or the suspension. Among these are, for instance, interactions between proteins and test components, e.g.: protein and protein, protein and nucleic acid, protein and lipid, protein (e.g. a lectin) and carbohydrate (e.g. a saccharide), protein and low- molecular compound (e.g. protein and metal ion at zinc finger proteins), protein and ligand (e.g. protein and peptide; protein and dye; antibody and antigen; receptor and hormone; protein and biomimetic; protein und drug; enzyme and substrate or substrate inhibitor; apoenzyme and prosthetic group; transport system and species), whereby non covalent interactions (via hydrogen bonds, hydrophobic interactions, Van der Waals interactions, metal complexation, metal bonding or electrostatic interactions (e.g. electrostatic bonds such as ion bonds and/or salt bonds) and covalent bonding can take place. An aim of such a procedure, being performed at non covalent bonding processes, can be the quantitative characterization (e.g. by determining the association constants or values of the binding kinetics) and/or qualitative characterization (e.g. of the kind of the interaction and/or dependence on temperature, pH value or ion strength) of the interactions. Further observed detectable interactions are e.g. nucleic acid and test component, peptide and test component, lipid and test component, carbohydrate and test component, drug and test component, metal chelate and test component, metal and test component, ionophore and ion, organelle and test component, virus and test component, cell and test component, tissue and test component.

If the surface occupancy is known (e.g. on an atomically flat surface), then also unknown concentrations of analytes in the solution can be determined (e.g. by attaching a nickel-chelate, which binds to the histidine tag of a dissolved protein).

Also, chemical linkages can be changed during the interaction processes, e.g. covalent bonds can be formed (for instance the covalent bonds when a disulfide bridge is formed) or broken. Among the interactions, which can be observed, are in particular all possible bio catalytic processes, particularly such from enzymes, catalytic nucleic acids, organelles, cells or tissues, which interact with substrates, cofactors, inhibitors or activators.

An aim of this procedure can be the determination of values of the enzyme kinetics. If the surface occupancy of enzyme or substrate is known (e.g. on an atomically flat surface), also unknown concentrations of analytes (substrate or enzyme) in the solution can be concluded by means of the enzymatic conversion of the substrate. For example, an enzymatic process can be the phosphorylation (and/or dephosphorylation) or glycosylation of a protein. Further, changes in conformation of spatial structures, in particular of the protein tertiary and/or quaternary structure, can be observed, e.g. protein folding or structural changes of protein ligand complexes by an increase of temperature (from this, thermodynamic variables of molecular interactions can be deduced).

The characteristics of the invention being disclosed in the preceding description, the subsequent drawings and claims can be of importance both singularly and in arbitrary combination for the implementation of the invention in its different embodiments.

The foregoing description of preferred embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is

1. A method for producing an arrangement having several layers, the method comprising the steps of:
forming, under the influence of light, an organic layer on a surface of a semiconductor substrate by applying a medium, which contains an organic substance to the surface of the semiconductor substrate and depositing the organic substance on the surface of the semiconductor substrate;
inducing a photochemical reaction in the medium and/or the semiconductor substrate; and
applying an electrical voltage at the deposition of the organic substance for setting a difference of potential between the semiconductor substrate and the medium.

2. The method according to claim 1, wherein the organic layer is deposited as a linking layer for coupling species or as a close packed organic linking layer on the surface of the semiconductor substrate or a surface of n- or p-doped silicon by applying a medium or a solvent, which contains an organic substance or a linker molecule, on the surface of the semiconductor substrate, and the organic substance is deposited, wherein a photochemical reaction is induced in the medium and/or the semiconductor substrate by a release of photo radicals by photolysis, by the irradiation of light or ultraviolet light, and setting a difference of potential between the semiconductor substrate and the medium or setting a non anodic potential or a current with fixed current flow direction or a charge quantity with fixed sign, during the deposition of the organic substance by applying an electrical voltage or a constant voltage with the help of electrical means or electrodes conductively contacting the semiconductor substrate and the medium.

3. The method according to the claim 1, wherein the organic substance is bonded covalently to the semiconductor substrate or to a surface of silicon or to a hydrogen-terminated surface of silicon by HL-N or HL-C bonds (HL—semiconductor substrate or silicon or titanium dioxide, N—nitrogen, C—carbon) between the organic substance and the semiconductor substrate, the organic substance having at least one group for coupling species or a biologically active component, to which one or more biologically active components are coupled by a chemical reaction and/or by non covalent interactions between the biologically active component and the at least one group for coupling.

4. The method according to claim 1, wherein the organic substance is formed on the basis of a photoreactive compound or an aryl azide compound, a benzophenone derivative, a heterocylcic compound and/or a diazirine derivative, the diazirine derivative being a halogen aryl azide compound or the heterocylcic compound being NMP.

5. The method according to claim 1, wherein the surface of the semiconductor substrate is the surface of a silicon single crystal or poly crystal or the surface of a silicon single crystal or poly crystal of {111} or {110} or {100} surface orientation or main surface orientation or the surface of amorphous silicon and/or is atomically flat and/or wherein at least one of the layers is lithographically structured or fashioned by an imprinting procedure or quantum dots are formed in the organic layer.

6. The method according to claim 1, wherein the potential is set for the directed adjustment, compared to the surface of the substrate, of the photo radicals in the organic layer by applying the voltage for the setting of a non anodic potential or a current with fixed flow direction by means of a source of voltage or current or a potentiostat.

7. The method according to claim 1 wherein the electric voltage being applied is a constant electric voltage, or a voltage for constant non anodic potential, or wherein the current is a constant current, or wherein the charge is a predefined charge quantity, and/or where the photochemical reaction is induced by the irradiation of light with a wavelength to break bonds or the silicon hydrogen bond, or the medium is irradiated to form organic radicals with a wavelength to break bonds or by ultraviolet light or optically visible light.

8. The method according to claim 1, further comprising the step of measuring a photoelectric voltage and/or an electrical conductivity and/or a charge quantity and/or a photoluminescence of the surface via the semiconductor substrate or measuring an electrical quantity by a measuring device, like an ammeter or a voltmeter or a coulombmeter or a detector for light or a spectrometer.

9. A multilayer arrangement having a substrate layer being formed by a semiconductor substrate and an organic layer, which is formed on the surface of the semiconductor substrate by depositing an organic substance,
wherein the organic layer is bonded by covalent bonds to the semiconductor substrate and at least parts of the interface organic layer/semiconductor substrate are able to conduct charge carriers via the interface.

10. The multilayer according to claim 9, wherein a substrate layer is formed by a semiconductor substrate or a n- or p-doped semiconductor substrate or a terminated silicon surface or a hydrogen-terminated silicon surface, and an organic layer or a close packed organic layer is formed on the surface of the semiconductor substrate by depositing the organic substance, wherein the organic layer is bonded by covalent bonds to the semiconductor substrate or by covalent HL-N or HL-C bonds (HL—semiconductor substrate or silicon or titanium dioxide, N—nitrogen, C—carbon), which is formed by a photochemical reaction and an applied electric voltage, wherein the organic substance is bonded to the semiconductor substrate and has at least one chemical group for coupling a biologically active component to which one or more biologically active components may be coupled.

11. The multilayer arrangement according to claim 9, wherein the organic substance is formed on the basis of a photo reactive compound or an aryl azide compound, a benzophenone derivative and/or a diazirine derivative, the diazirine derivative being a halogen aryl azide compound or NMP.

12. The multilayer arrangement according to claim 9, wherein the surface of the semiconductor substrate is the surface of a silicon single crystal or poly crystal or the surface of a silicon single crystal or poly crystal of {111} or {110} or {100} surface orientation or main surface orientation or the surface of amorphous silicon and/or is atomically flat, and/or wherein at least one of the layers is lithographically structured or fashioned by an imprinting procedure or quantum dots are formed in the organic layer; and/or the parts of the interface organic layer/semiconductor substrate, able to conduct charge carriers via the interface, are free of silicon oxide.

13. The multilayer arrangement according to claim 9, wherein the multilayer arrangement measures a chemical reaction at the organic layer by a photoelectric voltage and/or a change in the electric conductivity and/or a charge quantity, by a measuring device, like an ammeter or a voltmeter or a coulombmeter or a detector for light or a spectrometer; and/or where charge transfer takes place or takes mainly place via or with the help of the bonds or covalent bonds between the organic substance and the conducting parts of the semiconductor substrate.

14. A biosensor comprising:
a semiconductor substrate layer;
an organic linking layer, which has been formed by depositing an organic substance on a surface of the semiconductor substrate layer, the organic linking layer being bonded to the semiconductor substrate layer by covalent bonds and the organic linking layer provides at least one chemical coupling group for coupling biologically active components;
one or more biologically active components being coupled to the at least one group for coupling; and
and at least parts of the interface organic layer/semiconductor substrate are able to conduct charge carriers via the interface.

15. The biosensor according to claim 14, wherein
the organic linking layer has been formed by depositing the organic substance by a light induced reaction or an electrochemical reaction or by the combination of a light induced reaction and an electrochemical reaction to the surface of the semiconductor substrate layer or a n- or p-doped semiconductor substrate layer or a terminated silicon surface or a H-terminated silicon surface or a titanium oxide layer, wherein the surface of the semiconductor substrate is the surface of a single crystal or poly crystal or the surface of a single crystal or poly crystal of {111} or {110} or {100} surface orientation or main surface orientation or the surface of amorphous substrate and/or is atomically flat, and/or wherein at least one of the layers is lithographically structured or fashioned by an imprinting procedure or quantum dots are formed in the organic layer, and/or where the parts of the interface organic layer/semiconductor substrate, able to conduct charge carriers via the interface, are free of silicon oxide, and
an interaction section, standing in contact with the biologically active component, is included, in which a test substance with a biological test component for interacting with the biologically active component can be brought in, and at least one connection electrode, which is electrically conductive connected with the test substance in the interaction section, and at least one further connection electrode, which is electrically conductive connected with the semiconductor substrate layer, wherein connectors for connecting to an electric circuit are formed by the at least one connection electrode and the at least one further connection electrode so that between the at least one connection electrode and the further connection electrode an electrical quantity can be measured via the arrangement comprising the semiconductor substrate layer and the organic linking layer and the interaction section, by a measuring device, like an ammeter or a voltmeter or a coulombmeter or a detector for light or a spectrometer, and wherein
a quantity changes its value in the case of an interaction of the biologically active component with the test component of the test substance in the interaction section.

16. The biosensor according to claim 14, wherein a non closed layer of silicon oxide is formed on a silicon substrate layer and/or parts of the organic layer are directly bonded to the oxide free silicon without intermediate layer and/or the conduction of charge carriers via the interface organic layer/semiconductor substrate takes place or takes mainly place via silicon oxide free parts and/or via or with the help of the bonds or covalent bonds between the organic substance and the conducting parts of the semiconductor substrate.

17. The biosensor according to claim 14, wherein the interaction section is formed as a section with a supply opening and a discharge opening for the passing through of the test substance such as a flow-through section may be.

18. The biosensor according to claim 14, wherein chemical bonds are formed between the organic linking layer and the semiconductor substrate layer, the chemical bonds being HL-N bonds or HL-C bonds (HL—semiconductor substrate or silicon or titanium dioxide, N—nitrogen, C—carbon).

19. The biosensor according to the claim 18, wherein the chemical bonds between the organic linking layer and the semiconductor substrate layer are derived from an irridiated photoreactive compound, an azide compound, a halogen aryl azide compound, a benzophenon derivative, a hetrocyclic compound, and/or a diazirin derivative.

20. A procedure for measuring characteristics of a test component in a test substance by a biosensor for detecting biomolecules, the procedure, wherein:
the test substance including the test component is brought in an interaction section of a biosensor or a sensor according to one of the claims 14 to 19, which includes an arrangement of several layers, comprising a semiconductor substrate layer or a silicon surface and a layer with a biologically active component being located adjacently to the semiconductor substrate layer or bonded to the silicon surface, the layer with the biologically active component being in connection with the interaction section so that the biologically active component and the test component interact if the test substance is brought into the interaction section;
at least one connection electrode, which is electrically conductive connected with the test substance in the interaction section, and at least one further connection electrode, which is electrically conductive connected with the semiconductor substrate layer, are connected with an electric circuit by interconnecting the arrangement of several layers and the interaction section;
charge transfer from the semiconductor to the organic layer is predominant via semiconductor-organic layer interface regions which are free or mainly free of non conducting semiconductor surface termination material or silicon oxide or metal; and
an electrical quantity, which changes its value in the case of an interaction between the biologically active component of the layer and the test component in the test substance, is measured by measuring a current or a potential or charge flow or charge to determine the electric conductivity at a constant current or potential or to determine the charge quantity, via the arrangement of several layers and the interaction section with the help of a measuring instrument or an ammeter or a voltmeter or a coulombmeter, being included in the electric circuit.
